(19) United States
(12) Patent Application Publication
(10) Pub. No.: US 2011/0037259 A1
(43) Pub. Date: Feb. 17, 2011

(54) CONNECTOR FOR GAS OR LIQUID LINES AND USE THEREOF

(75) Inventors: Claus Rade, Allmendingen (DE); Alexander Piechulla, Blaubeuren (DE); Robert Scherer, Lauffen (DE)

Correspondence Address: LERNER GREENBERG STEMER LLP, P O BOX 2480, HOLLYWOOD, FL, 33022-2480, US

(73) Assignee: CENTROTHERM THERMAL SOLUTIONS GMBH & CO. KG, Blaubeuren (DE)

(21) Appl. No.: 12/852,055

(22) Filed: Aug. 6, 2010

Related U.S. Application Data
(60) Provisional application No. 61/239,283, filed on Sep. 2, 2009.

(30) Foreign Application Priority Data
Aug. 6, 2009 (DE) 10 2009 036 320.3

(51) Int. Cl. F16L 21/02; F16L 21/00

(52) U.S. Cl. 285/370; 285/397

(57) ABSTRACT

A connector for gas or liquid lines has a core piece with a core and a sleeve piece with a sleeve. A pressure space surrounds the core and the sleeve when the two are connected to one another. The pressure space is set at an overpressure with respect to a line space of the connector. The connector is useful, for example, in connecting a diffusion tube of a low-pressure diffusion furnace to a gas outlet lance.

### CROSS-REFERENCE TO RELATED APPLICATION

This application claims the benefit, under 35 U.S.C. §119(e), of provisional patent application No. 61/239,283, filed Sep. 2, 2009; the application also claims the priority, under 35 U.S.C. §119(a), of German patent application No. 10 2009 036 320.3, filed Aug. 6, 2009; the prior applications are herewith incorporated by reference in their entirety.

### BACKGROUND OF THE INVENTION

### Field of the Invention

The invention relates to a connector for gas or liquid lines. The connector has a core piece with a core and a sleeve piece with a sleeve. The connector is suitably used to connect the diffusion tube of a low-pressure diffusion furnace and a gas outlet lance.

Connectors for gas or liquid lines are employed in many applications. In general, a leaktightness of the line connection made by means of the connector is desired. Moreover, the media transported in the lines to be connected often require the connector to be manufactured from materials suitable for these media. Thus, for example, core and sleeve pieces consisting of heat-resistant quartz glass have long been used as a connector, insofar as this is exposed to high temperatures. However, connection by means of form-fit core and sleeve pieces often does not afford sufficient leaktightness. For this reason, additional sealing materials, for example PTFE cuffs (PTFE: polytetrafluoroethylene), have hitherto been introduced between the core and sleeve pieces. However, those sealing materials are heat-resistant to only a limited extent, thus, in turn, entailing restrictions in the use of the connector or in process management in the respective application.

This proves to be a problem in certain applications. Among others, this involves low-pressure diffusion plants, such as are used, for example, for the diffusion of dopant into silicon substrates. In that case, often, a carrier gas, usually nitrogen, is conducted through phosphoroxychloride (POCl₃) and is introduced, together with entrained vaporous phosphoroxychloride, into a diffusion tube containing silicon wafers which are to be diffused and which are heated to temperatures of about 750 to 900° C. With the admixture of oxygen, the following reactions take place:

4POCl₃+3O₂→2P₂O₅+6Cl₂

P₂O₅+O₂+Si→SiO₂:P

Not only chlorine gas (Cl₂) arises as a reaction product, but also phosphorus pentoxide (P₂O₅) which is not converted further into phosphorus silicate glass (SiO₂:P) and, together with chlorine gas and carrier gas, has to be transported away from the diffusion tube.

In the prior art, it is known, for this purpose, to provide at one end of the diffusion tube a core piece which has a core with a surface in the form of a spherical segment, this often being designated as a spherical ground joint. The core piece, like the diffusion tube, is manufactured from quartz glass and is usually connected to this in one piece. Furthermore, the core piece is connected with a form fit to a sleeve piece which conducts the gases to be discharged further on, for example into a cooling trap. It has been shown, however, that such connectors are often not sufficiently leaktight, for example on account of manufacturing tolerances in a grinding of the core in the form of a spherical segment or in the grinding of the dimensionally complementary sleeve of the sleeve piece. This may have adverse effects particularly in low-pressure diffusion plants, since ambient air may pass into the diffusion tube there as a result of an inadequate leaktightness of the connector. In order to prevent this, a PTFE cuff is conventionally inserted between the core and sleeve. However, above 300° C., this cuff decomposes into toxic constituents, and therefore this temperature should not be overshot.

At the same time a condensation of phosphorus pentoxide on the quartz glass wall of the diffusion tube or of the connector can be avoided only if the wall of these components is sufficiently hot. The condensation of phosphorus pentoxide commences even at temperatures of less than 350° C. Complicated temperature control is therefore necessary, which, however, cannot completely prevent the deposition of phosphorus pentoxide, but at most reduce it. If formed phosphorus pentoxide comes into contact with water, for example with water vapor from the ambient air during maintenance work or when the diffusion tube is loaded with substrates, such as silicon wafers, the formation of acids which damage the quartz glass occurs. Consequently, the diffusion tubes and other quartz glass parts are quickly destroyed and have to be replaced with considerable outlay.

### SUMMARY OF THE INVENTION

It is accordingly an object of the invention to provide a connector for gas or liquid lines which overcomes a variety of disadvantages of the heretofore-known devices and methods of this general type, which is specifically suited for use as a connector between a diffusion tube of a low-pressure diffusion furnace and a gas outlet lance, and which provides for a heat-resistant connector that safely avoids an ingress of ambient gases into a low-pressure line at the connection point.

With the foregoing and other objects in view there is provided, in accordance with the invention, a connector for gas or liquid lines, comprising:
a core piece with a core;
a sleeve piece with a sleeve;
said core and said sleeve, in a connected state, surrounding a line space for conducting gas or liquid;
a device forming a pressure space surrounding said core and said sleeve in the connected state thereof and being set to an overpressure with respect to a pressure in said line space.

The connector according to the invention has a core piece with a core and a sleeve piece with a sleeve. The basic idea of the invention is to provide a pressure space which, in the connected state, surrounds the core and the sleeve and in which an overpressure can be generated with respect to a line space of the connector.

The pressure space may in this case have a gas inlet for the introduction of gas. The pressure for the pressure space could also be set via such a gas inlet.

The line space of the connector is to be understood as meaning that space in which the gases or liquids are conducted through the connector. When an overpressure is generated in the pressure space with respect to the line space, it is possible, in the case of an insufficiently leaktight form-fit connection between the core and sleeve, to ensure that a pressure medium arranged in the pressure space penetrates at most into the line space and into other spaces connected to the latter. The pressure medium which is in this case arranged in the pressure space is a medium which, if it penetrates into the line space, is harmless for process management in the respective application. For example, it may be a water-free gas, in particular an inert gas, such as nitrogen, or a noble gas.

Thus, an additional sealing means, such as, for example, a PTFE cuff, arranged between the core and sleeve may be dispensed with. The core piece and sleeve piece are manufactured from a material sufficiently temperature-resistant for the respective application, preferably from quartz glass. The connector is therefore heat-resistant, and the ingress of ambient gases into the line space is avoided.

According to a development of the connector according to the invention, the pressure space can be closed, gas-tight, with respect to surroundings. The term “gas-tight” means in this context that the pressure space is designed to be at least leaktight with respect to a penetration of gases from the surroundings. Preferably, moreover, the pressure space is also leaktight with respect to an escape of gases arranged in the pressure space, and, particularly preferably, is also leaktight with respect to an escape of gases transported in the gas or liquid lines in the respective application or with respect to gases from the pressure space which arise from the transported liquids.

In a preferred design variant of the invention, the core has a surface in the form of a spherical segment and the sleeve has a surface dimensionally complementary to this, so that, in the connected state, the sleeve and core are connected with a form fit to one another. Such a core surface configuration in the form of a spherical segment is often designated as a spherical ground joint when glasses, in particular quartz glass, are used as material for the core. Instead of a surface in the form of a spherical segment, a cylindrical surface or a surface in the form of a conical segment may in principle also be provided. In the case of glass materials, this is often designated as a cylindrical or conical ground joint.

In a further preferred design variant of the invention, the pressure space has at least one gas inlet for the supply of a scavenging gas and at least one gas outlet for the discharge of the scavenging gas. As a result, any ambient air penetrating into the pressure chamber can be removed effectively from the pressure space. Moreover, before the connector is commissioned, the pressure space can easily be freed of ambient air or other undesirable media. The scavenging gas provided for the pressure space may be heated before being introduced into the pressure space, advantageously to a temperature of more than 300° C. Further, the heated scavenging gas would flow at least partially through the pressure space and leave the pressure space again through the gas outlet for the purpose of discharging the scavenging gas.

In an advantageous design variant of the invention, a pressure prevailing in the pressure space can be set. For this purpose, corresponding pumps or pressure sources and also a suitable control device are provided. Preferably, the pressure prevailing in the pressure space can be regulated in relation to a pressure prevailing in the line space, and a corresponding regulating device is provided. In an advantageous design variant, therefore, at least one pressure measurement device is arranged in the pressure space. Thus, the difference between the pressure prevailing in the pressure space and the pressure prevailing in the line space can be controlled or regulated. It has proved appropriate, in practice, to provide a pressure difference of less than 10% of the pressure prevailing in the line space, in order, in the event of leaks between the sleeve and core, to ensure that only a little of the pressure medium arranged in the pressure space passes into the line space.

According to a development of the invention, a first element from a group consisting of the sleeve piece and core piece has a tubular portion which, in the connected state, is arranged at least partially in another element of the group; in particular, the tubular portion may be surrounded at least partially by the other element of the group. The stability of the connector can thereby be increased. Moreover, the risk is reduced that, in the event of damage to the connector in the line space, for example due to the action of acid, the sleeve piece and the core piece are damaged. If appropriate, in such a case, repair may be restricted to the exchange of only that element which has the tubular portion.

Against this background, in a preferred design variant of the invention, the tubular portion completely lines an inner wall of the other element. If, in a connector configured in this way, damage to the connector in the line space occurs, as a rule, only that element having the tubular portion needs to be exchanged. For the further reduction in the risk of damage to that element which is lined by the tubular portion, according to an advantageous design variant the tubular portion bears against the inner wall of the other element.

In a design variant of the connector according to the invention, the sleeve piece has a tube, around the outer surface area of which the sleeve extends in the form of a collar. The tube and the sleeve are in this case preferably connected to one another in one piece.

In a further design variant, the core piece has a tube, around the outer surface area of which the core extends in the form of a collar. The tube and the core are in this case, again, preferably connected to one another in one piece. In an especially preferred design variant, the core ends flush with the sleeve of the sleeve piece.

In a development of the connector according to the invention, a heating device, at least partially surrounding the sleeve piece and/or the core piece, is provided for heating a medium located in the sleeve piece and/or the core piece. As a result, in corresponding applications, the risk of an undesirable condensation of media located in the connector can be reduced.

The same purpose is served by another development of the connector according to the invention, which provides an insulation which at least partially surrounds the sleeve piece and/or the core piece circumferentially. Preferably, in this case, the insulation provided is a ceramic insulation.

In a development of the invention, the sleeve piece and/or the core piece are/is manufactured at least partially from a colored material. What can be achieved thereby is that the sleeve piece and/or the core piece absorb/absorbs heat radiation emitted by a heat source more efficiently, so that the connector at least partially assumes a higher temperature than without coloring, as a result of which, in certain applications, the risk of the condensation of substances present in the line space can be reduced. Preferably, the sleeve piece and/or the core piece are/is manufactured at least partially from a colored glass and, especially preferably, from a colored quartz glass.

The connector according to the invention may advantageously be used for connecting a diffusion tube of a low-pressure diffusion furnace to a gas outlet lance. In other words, there is also provided, in accordance with the invention, and in combination with a low-pressure diffusion furnace having a diffusion tube, a connector as outlined above mounted to connect the diffusion tube of the low-pressure diffusion furnace to a gas outlet lance.

A low-pressure diffusion furnace is to be understood in the present case to mean a diffusion furnace in which diffusion takes place at a pressure that is lower than atmospheric pressure, preferably at a pressure of 50 to 250 mbar.

Process and reaction gases are discharged from the diffusion tube by way of the gas outlet lance. These gases are usually delivered to a cooling trap.

In an advantageous design variant, the pressure space is acted upon by a pressure which is only slightly higher than a pressure prevailing in the line space. The difference preferably amounts to less than 10% of the pressure prevailing in the line space. As already indicated above, what can be brought about thereby is that, in the event of a leak between the core and sleeve, only a small quantity of the gas arranged in the pressure space passes into the line space and from there into the diffusion tube. In a design variant of the use according to the invention, the core piece or sleeve piece is connected to the diffusion tube, preferably in one piece, and the counterpiece, that is to say the sleeve piece or core piece, is connected to the gas outlet lance. The latter connection is preferably, again, made in one piece.

In an especially preferred design variant, the core piece is connected to the diffusion tube, the connection preferably being made in one piece. This is advantageous, inter alia, insofar as the core piece is usually at less risk of fracture than the sleeve piece, and therefore, in this design variant, the risk that the entire diffusion tube has to be exchanged is reduced.

Advantageously, in the use according to the invention, a water-free gas is arranged in the pressure space. Furthermore, the pressure space is preferably scavenged by the water-free gas. This can prevent a situation where, in the event of a leak between the core and sleeve and a penetration of a gas from the pressure space into the line space, the connector or the diffusion tube is damaged. The use of an inert gas as a water-free gas is especially advantageous. It has proved appropriate, in practice, to provide the carrier gas for diffusion, that is to say, as a rule, nitrogen, as water-free gas in the pressure space.

Other features which are considered as characteristic for the invention are set forth in the appended claims.

Although the invention is illustrated and described herein as embodied in a connector for gas or liquid lines and its use, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a section through an exemplary embodiment of a connector according to the invention; and

FIG. 2 is a sectional view showing the implementation of the connector according to the invention in a low-pressure diffusion furnace.

### DETAILED DESCRIPTION OF THE INVENTION

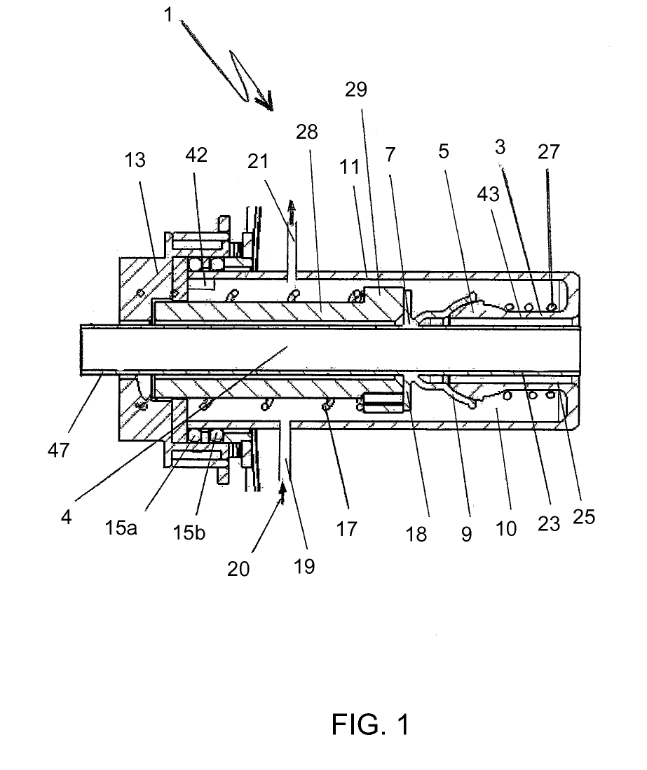

Referring now to the figures of the drawing in detail and first, particularly, to FIG. 1 thereof, there is shown a first exemplary embodiment of a connector 1 according to the invention in the connected state. A core 5 with a surface, in the form of a spherical segment, of a core piece 3 is in this case arranged with a form fit in a sleeve 9 of a sleeve piece 7. The core piece 3 is connected in one piece to a wall element 11 which, together with an O-ring pinch connection 13, forms a pressure space 10 which surrounds the core 5 and the sleeve 9.

The pressure space 10 can be closed, gas-tight, with respect to the surroundings by means of the O-ring pinch connection 13. This is brought about by a pinching of the O-rings 15a, 15b.

The sleeve piece 7 is supported elastically, by means of a helical spring 17 which partially surrounds the sleeve piece 7, with respect to a surface, located in the pressure space 10, of the O-ring pinch connection 13 and therefore with respect to an inner wall of the pressure space 10. Support takes place via a shaped-out portion 29, bearing against the helical spring 17, of a ceramic insulation 28, the shaped-out portion 29 being supported, in turn, on a stop 18 of the sleeve piece 7. Thus, a spring force emanating from the helical spring 17 is transmitted to the sleeve piece 7 via the shaped-out portion 29 and the stop 18. The spring force in this case causes the core 5 and sleeve 9 to be pressed one against the other with a defined force.

In the exemplary embodiment of FIG. 1, the core 5 has a surface in the form of a spherical segment and the sleeve 9 has a surface dimensionally complementary thereto. In the connected state of the connector 1, as illustrated, the sleeve 9 and core 5 are correspondingly connected to one another with a form fit. As stated above, other geometries may also be used, for example cylindrical surfaces or surfaces in the form of a conical segment.

The pressure space 10 has a gas inlet 19 for the supply of a scavenging gas 20 into the pressure space 10. The scavenging gas 20 can be discharged via a gas outlet 21. Instead of the gas inlet 19 and the gas outlet 21, it is also conceivable to provide only a gas inlet, via which the pressure space 10 is first evacuated and subsequently filled with a gas, for example an inert gas. The scavenging gas may be heated before being introduced into the pressure space, preferably to a temperature higher than 300° C., and the connector 1 may be heated by means of the scavenging gas. The risk of a condensation of substances located in the line space can thereby be reduced.

On account of the introduction of the scavenging gas 20 into the pressure space 10 or of the evacuation and subsequent filling of the pressure space 10 with a gas, a pressure is generated in the pressure space. This pressure prevailing in the pressure space 10 may be controlled in a way known per se by means of pumps, pressure sources and valves. In an especially advantageous design variant, the pressure prevailing in the pressure space 10 is regulated, for example in relation to a pressure prevailing in a line space 4 formed by the core piece 3 and the sleeve piece 7. To allow corresponding regulation or else only to determine a pressure prevailing in the pressure space 10, a pressure measurement device 42 is arranged in the pressure space 10.

In the exemplary embodiment of FIG. 1, the core piece 3 has a core tube 43, around the outer surface area of which the core 5 extends in the form of a collar. The core tube 43 and core 5 are connected to one another in one piece. Correspondingly, the sleeve piece 7 has a sleeve tube 47, around the outer surface area of which the sleeve 9 extends in the form of a collar. The sleeve tube 47 and sleeve 9 are likewise connected to one another in one piece.

The sleeve tube 47 has a tubular portion 23 which, in the connected state, is arranged in the core piece 3. As may be gathered from FIG. 1, this tubular portion 23 completely lines an inner wall 25 of the core piece 3. As stated above, what can be brought about thereby is that, in the event of damage to the connector in the line space 4, only the sleeve piece 7 has to be exchanged, but, in most cases, the core piece 3 can be left as it is.

In the sectional illustration of FIG. 1, it can be seen that the tubular portion 23 is arranged spaced apart from the inner wall 25 of the core piece 3. However, a further reduction in the risk of damage to the core piece 3 could readily be achieved in that the tubular portion 23 bears against the inner wall 25 of the core piece 3.

The insulation 28, which in the present case is designed as ceramic insulation 28, partially surrounds the sleeve piece 7 circumferentially and thereby reduces a cooling of a medium carried in the line space 4. Such cooling is also counteracted by a heating device 27 by which the core piece 3 is partially surrounded in FIG. 1. Both the ceramic insulation 28 and the heating device 27 may serve for preventing an undesirable condensation of substances carried in the line space 4 on the walls of the core piece 3 or of the sleeve piece 7.

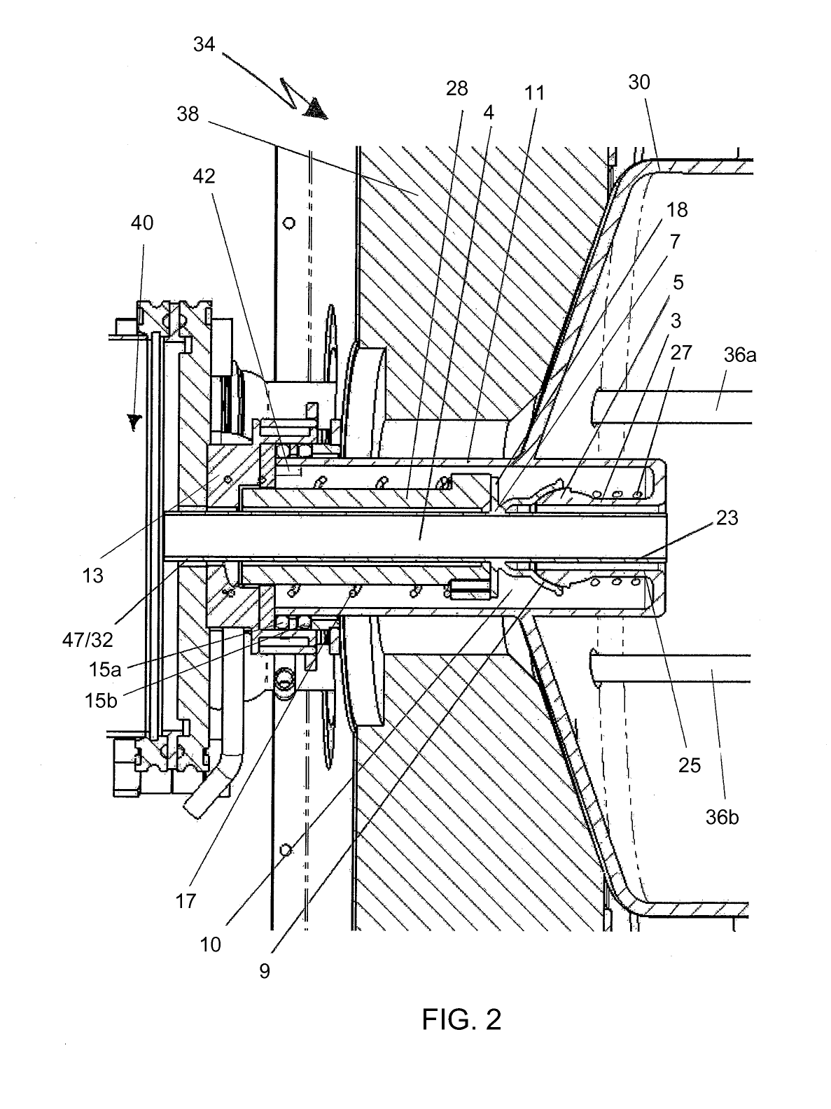

FIG. 2 shows, in a sectional illustration, the use of the connector from FIG. 1 for connecting a diffusion tube 30 of a low-pressure diffusion furnace 34 to a gas outlet lance 32. Neither the gas inlet 19 nor the gas outlet 21 are reproduced in FIG. 2 for the sake of greater clarity. The low-pressure diffusion furnace is illustrated only partially for the same reason.

In the exemplary embodiment of FIG. 2, the core piece 3 is connected in one piece to the diffusion tube 30. The sleeve tube 47 serves as a gas outlet lance 32, via which carrier and reaction gases can be supplied from the diffusion tube 30 via the line space 4 to a cooling trap 40. The diffusion tube 30 is insulated with respect to the surroundings by means of an insulation 38. Process gases are supplied to the diffusion tube 30 via gas inlet pipes 36a, 36b.

When POCl₃ diffusion is carried out in the diffusion tube 30, nitrogen used as a carrier gas and also phosphorus pentoxide not converted into phosphorus silicate glass are discharged from the diffusion tube 30 via the gas outlet lance 32 or the sleeve tube 47 and delivered to the cooling trap 40. A condensation of the phosphorus pentoxide on the core piece 3 is prevented by the heating device 27. In the exemplary embodiment of FIG. 2, both the core piece 3 and the sleeve piece 7 and the diffusion tube 30 are manufactured from quartz glass. Since no additional sealing cuff, for example consisting of PTFE, is required in the connector 1 according to the invention, the core piece 3 can readily be heated by means of the heating device 27. If the heating device 27 has sufficient heating capacity, this also leads to a heating of the sleeve piece 7, the cooling of which is reduced as a result of its encasing with the ceramic insulation 28, so that here, too, there is no precipitation of phosphorus pentoxide. For the better absorption of heat radiation, whether from the heating device 27 or from other heat sources, the core piece 3 and sleeve piece 7 are also manufactured from colored quartz glass. Nitrogen is provided as scavenging gas 20 in the pressure chamber 10. Since this is already used as carrier gas for POCl₃, no additional inert gas source is required.

Should a condensation of phosphorus pentoxide nevertheless occur in the line space 4, for example because of operating errors, and, moreover, water vapor be introduced into the line space 4, for example during maintenance work, only damage to the sleeve tube 47 and therefore to the sleeve piece 7 would occur. This is due to the fact that the tubular portion 23 of the sleeve tube 47 completely lines the inner wall 25 of the core piece 3. The repair work would therefore be restricted to a repair or the exchange of the sleeve piece 7. By contrast, the core piece 3 could be left as it is. Since the latter is connected in one piece to the diffusion tube 30, this means a considerably lower outlay in terms of repair.

1. A connector for gas or liquid lines, comprising:
a core piece with a core;
a sleeve piece with a sleeve;
said core and said sleeve, in a connected state, surrounding a line space for conducting gas or liquid;
a device forming a pressure space surrounding said core and said sleeve in the connected state thereof and being set to an overpressure with respect to a pressure in said line space.

2. The connector according to claim 1, wherein said device for forming said pressure space is, at least partially, a wall element connected to one of said core piece and said sleeve piece.

3. The connector according to claim 2, wherein said wall element is integrally formed in one piece with said core piece or said sleeve piece.

4. The connector according to claim 1, wherein said pressure space is sealable to be gas-tight with respect to surroundings.

5. The connector according to claim 4, which comprises a pinch connection configured to close said pressure space gas-tight with respect to the surroundings.

6. The connector according to claim 5, wherein said pinch connection is an O-ring pinch connection assembly.

7. The connector according to claim 1, wherein, in the connected state, said sleeve piece or said core piece is supported elastically, pressing said core and said sleeve against one another with a defined force.

8. The connector according to claim 7, wherein said sleeve piece or said core piece is elastically supported with respect to an inner wall of said pressure space.

9. The connector according to claim 7, which comprises a helical spring elastically supporting said sleeve piece or said core piece, said helical spring at least partially surrounding said sleeve piece or said core piece.

10. The connector according to claim 1, wherein said core is formed with a surface in the form of a spherical segment and said sleeve has a dimensionally complementary surface, such that, in the connected state, said sleeve and said core are connected to one another with a form fit.

11. The connector according to claim 1, wherein said pressure space has at least one gas inlet for supplying a scavenging gas thereto and at least one gas outlet for discharging the scavenging gas therefrom.

12. The connector according to claim 1, wherein a pressure prevailing in said pressure space can be set and can be regulated.

13. The connector according to claim 12, wherein the pressure prevailing in said pressure space is regulated with reference to a pressure prevailing in said line space.

14. The connector according to claim 1, wherein a first element formed of a group consisting of said sleeve piece and said core piece has a tubular portion which, in the connected state, is arranged at least partially in another element of said group.

15. The connector according to claim 14, wherein said tubular portion completely lines an inner wall of said other element of said group.

16. The connector according to claim 15, wherein said tubular portion bears against the inner wall of said other element.

17. The connector according to claim 1, which comprises a heating device, at least partially surrounding one or both of said sleeve piece and said core piece, for heating a medium located therein.

18. The connector according to claim 1, which comprises an insulation at least partially surrounding one or both of said sleeve piece and said core piece circumferentially.

19. The connector according to claim 18, wherein said insulation is a ceramic insulator.

20. The connector according to claim 1, wherein at least one of said sleeve piece and said core piece is manufactured, at least partially, from a colored material.

21. The connector according to claim 20, wherein said colored material is colored quartz glass.

22. In a low-pressure diffusion furnace having a diffusion tube, the connector according to claim 1 mounted to connect the diffusion tube of the low-pressure diffusion furnace to a gas outlet lance.

23. The combination according to claim 22, wherein said core piece is integrally connected in one piece with said diffusion tube.

24. The combination according to claim 22, which comprises a water-free gas disposed in said pressure space.

25. The combination according to claim 24, wherein said pressure space is scavenged by said water-free gas.
